(19) United States
(12) Patent Application Publication
(10) Pub. No.: US 2025/0368013 A1
(43) Pub. Date: Dec. 4, 2025

(54) Vehicle Hood Device

(71) Applicant: Logan Black, Phoenix, AZ (US)

(72) Inventor: Logan Black, Phoenix, AZ (US)

(21) Appl. No.: 18/732,343

(22) Filed: Jun. 3, 2024

(51) Int. Cl. B60J 3/02

(52) U.S. Cl. CPC B60J 3/0278

(57) ABSTRACT

In an embodiment, a vehicle hood device includes a solid body bounding and defining a window, the window having a top, a bottom, and opposed sides. The solid body includes a visor projecting above the top of the window, opposed piers flanking the window at the opposed sides thereof, and a base rail extending along the bottom of the window between the opposed piers. The device includes a mating surface on a back of the body, wherein the mating surface has an upper channel across the visor along the back of the body and a lower channel extending continuously across the piers and the base rail along the back of the body.

### FIELD

The present specification relates generally to motor vehicles, and more particularly to accessories for use with motor vehicles.

### BACKGROUND

Many modern motorcycles now come equipped with large touchscreens for displaying information to the motorcycle rider. On some bikes, these have largely replaced the analog and digital dials and buttons once prevalent. Unfortunately, touchscreen displays can be incredibly difficult to read in sunlight, a condition in which many people like to ride. When the rider cannot see the information on the screen, he cannot understand how his motorcycle is operating, he cannot change controls, he cannot even change the radio. And, taking his eyes off the road to adjust to a sunlit screen poses a real danger while riding. A solution is needed.

### SUMMARY

In an embodiment, a vehicle hood device includes a solid body bounding and defining a window, the window having a top, a bottom, and opposed sides. The solid body includes a visor projecting above the top of the window, opposed piers flanking the window at the opposed sides thereof, and a base rail extending along the bottom of the window between the opposed piers. The device includes a mating surface on a back of the body, wherein the mating surface has an upper channel across the visor along the back of the body and a lower channel extending continuously across the piers and the base rail along the back of the body.

In embodiments, the visor extends along a horizontal axis between opposed ends of the visor, includes a central portion above the window, and includes opposed lobes outside the central portion and outboard of the piers. The lobes turn downward from the horizontal axis. There is a back plane at the back of the body, and the upper channel, the lower channel, and the window are at the back plane. The upper channel includes a first surface extending forwardly from the back plane and a second surface extending upwardly from the first surface. The second surface of the upper channel is forward of the base rail. The lower channel includes a major concavity along the base rail which is in communication with minor concavities in the piers, and the minor concavities extend contiguously from the major concavity and flatten toward the upper channel. The visor projects forwardly to a free edge, and the piers project forwardly from the base rail to the free edge of the visor.

In an embodiment, a hood device includes a solid body bounding and defining a window, and a back surface of the solid body including an upper channel and a lower channel, wherein the upper channel is configured to mate against an upper rail of a motorcycle fairing and the lower channel is configured to mate against a dashboard of the motorcycle fairing, A visor projects forwardly from the back surface above the window. Opposed piers flank the window, and a base rail extends between piers below the window.

In embodiments, the visor extends along a horizontal axis between opposed ends, includes a central portion above the window, and includes opposed lobes outside the central window and outboard of the piers, and the lobes turn downward from the horizontal axis. There is a back plane at the back surface of the body, wherein the upper channel, the lower channel, and the window are at the back plane. The upper channel includes a first surface extending forwardly from the back plane and a second surface extending upwardly from the first surface. The second surface of the upper channel is forward of the base rail. The lower channel includes a major concavity along the base rail which is in communication with minor conccavities in the piers, and the minor concavities extend contiguously from the major concavity and flatten toward the upper channel. The visor projects forwardly to a free edge, and the piers project forwardly from the base rail to the free edge of the visor.

In an embodiment, a hood device includes a solid body defining a back plane and bounding a window at the back plane having a top, a bottom, and an opposed sides. The solid body includes a visor projecting forwardly from the back plane above the top of the window, and opposed piers flanking the window at the opposed sides thereof. There is a mating surface at the back plane of the body, wherein the mating surface includes an upper channel extending across the visor, and the mating surface is configured for mating contact with a fairing of a motorcycle.

In embodiments, the solid body further includes a base rail extending along the bottom of the window between the opposed piers. The mating surface further includes a lower channel extending continuously across the piers and the base rail. The upper channel includes a first surface extending forwardly from the back plane and a second surface extending upwardly from the first surface. The lower channel includes a major concavity along the base rail which is in communication with minor concavities in the piers, and the minor concavities extend contiguously from the major concavity and flatten toward the upper channel. The visor extends along a horizontal axis between opposed ends of the visor. The visor includes a central portion above the window and opposed lobes outside the central window and outboard of the piers. The lobes turn downward from the horizontal axis.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1 and 2 are top front and bottom front perspective views of a vehicle hood device, respectively;

FIGS. 3 and 4 are top rear and bottom rear perspective views of a vehicle hood device, respectively;

FIG. 5 is a section view taken along the line 5-5 in FIG. 3;

FIGS. 6 and 7 are perspective views of the vehicle hood device installed on a motorcycle fairing; and

FIG. 8 is a section view taken along the line 8-8 in FIG. 7.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

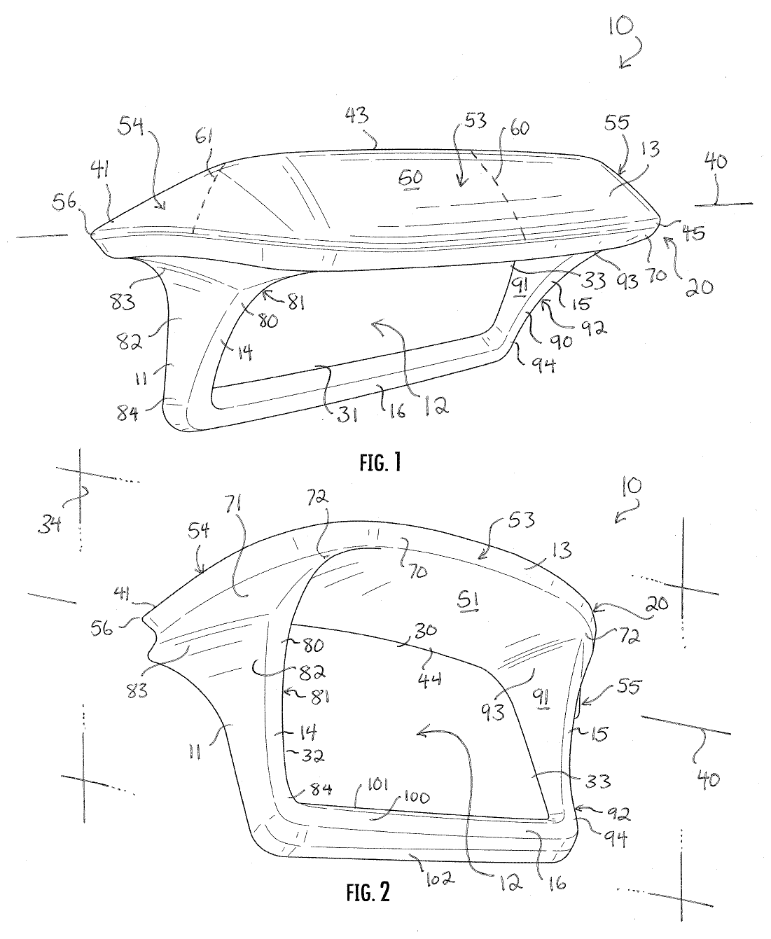

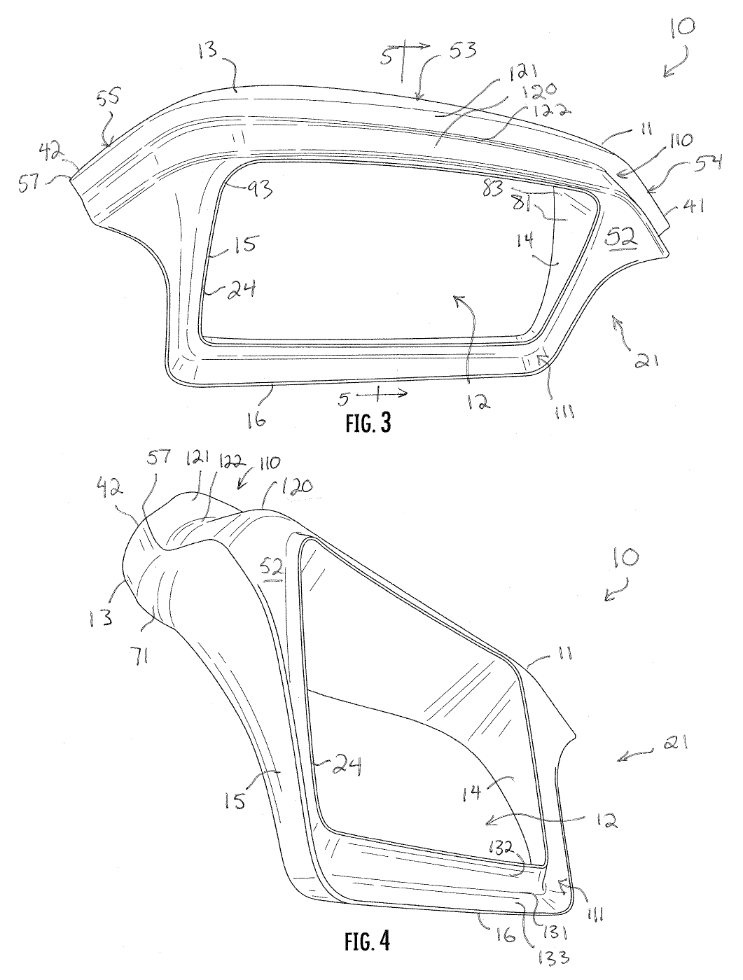

FIGS. 1 and 2 are front perspective views of a vehicle hood device 10 uniquely structured to shield and shade the electronic display of a motorcycle. The hood device 10 fits to a fairing of a motorcycle and casts shade onto an electronic display, allowing a rider to easily see the information on the display.

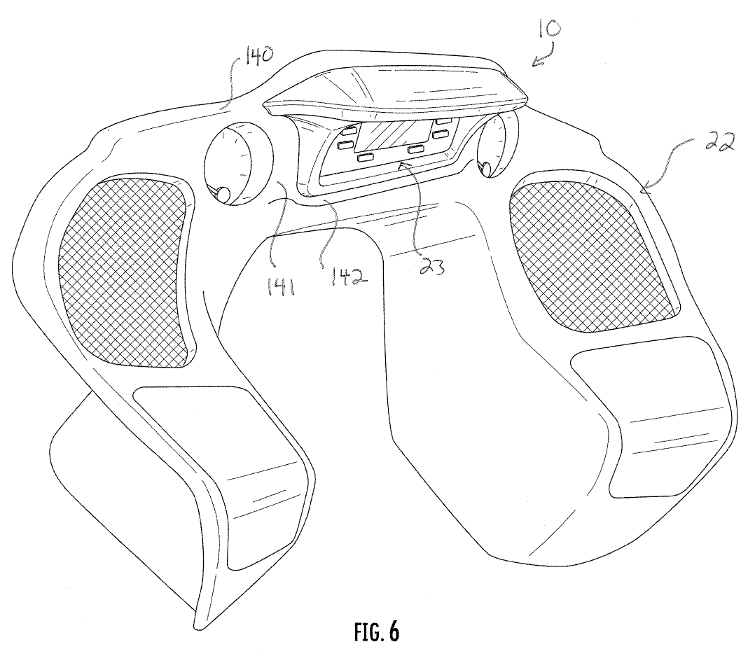

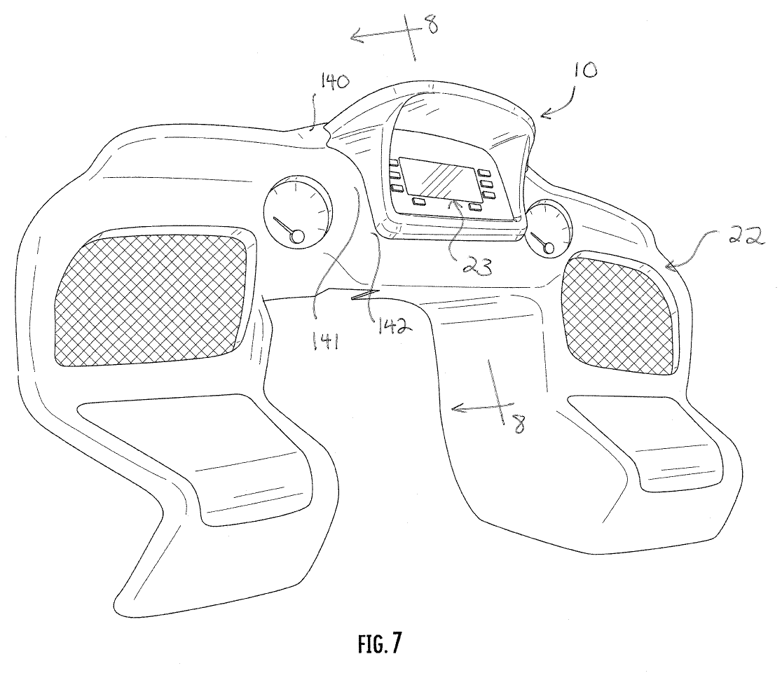

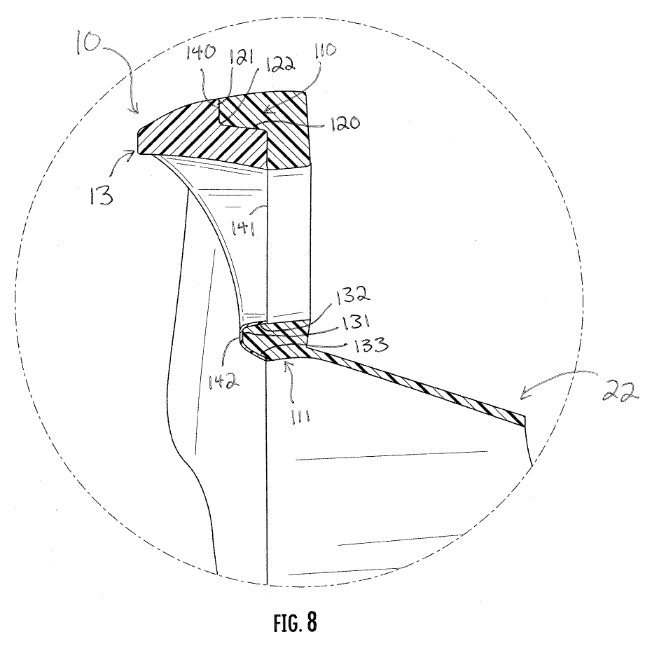

The hood device 10 has an unusual shape. It is constructed from a single, solid, rigid body 11 bounding and defining a roughly rectangular interior window 12. The hood device 10 (or “hood” 10) has a visor 13, opposed left and right piers 14 and 15 below the visor 13, and a base rail 16 at bottom between the piers 14 and 15. The hood 10 has a front 20, visible in FIGS. 1 and 2, and an opposed back 21. The back 21 mates to a motorcycle fairing 22 (seen in FIGS. 6 and 7), and the front 20 projects forwardly therefrom to shade an electronic display 23 set into the fairing 22. As an aside, the term “electronic display” is used here to describe, without limitation, electronic displays, touchscreen displays, non-touchscreen displays, digital displays, analog displays, and other screens, dials, buttons, and the like for displaying information.

The window 12 is roughly rectangular. It has a top 30, an opposed bottom 31, a left side 32, and an opposed right side 33. Its top 30 and bottom 31 are preferably longer than its sides 32 and 33. Preferably, but not necessarily, the top 30, bottom 31, left side 32, and right side 33 are generally linear and straight. The corners between the top 30 and the sides 32 and 33 are rounded, as are the corners between the bottom 31 and the sides 32 and 33. The window 12 has a height 35 between its top 30 and bottom 31 which is marked in FIG. 5 with the reference character 25. The window 12 lies in and defines a single back plane 34 (identified in FIG. 2). The back plane 34 is a thin plane at the back 21 of the hood 10 and contains the window 12. The window 12 is an opening or hole through the body 11 of the hood 10 allowing a rider seated on the motorcycle, in front of the hood 10, to see an electronic display 23 positioned in the window 12. The back 21 of the body 11 of the hood 10 terminates in a rearwardly-facing lip 24 bordering around the window 12.

Above the top 30 of the window 12, the visor 13 of the hood 10 projects forwardly. The visor 13 extends along a horizontal axis 40 between opposed ends 41 and 42 of the visor 13. The horizontal axis 40 is parallel to the back plane 34. The visor 13 has a top 43 at the top of the hood 10 and an opposed bottom 44 at the top 30 of the window 12. The visor 13 projects forwardly from the back 21 of the hood 10 to a free edge 45 between the top 43 and bottom 44 of the visor 13. The free edge 45 projects in front of the back plane 34 by a distance 46, which is approximately equal to the height 35 of the window 12.

The visor 13 includes three major surfaces: an upper surface 50, a lower surface 51, and a back surface or mating surface 52. The upper surface 50 extends between the top 43 of the visor 13 and the free edge 45 on the front 20 of the visor 13. It extends between the opposed ends 41 and 42 without interruption. The lower surface 51 extends between the bottom 44 of the visor 13 and the free edge 45 on the front 20 of the visor 13. It extends between the opposed ends 41 and 42 as well but is interrupted by the piers 14 and 15. The mating surface 52 of the visor 13 is on the back 21 of the hood 10 and defines a common mating surface 52 for the entire hood 10.

The upper and lower surfaces 50 and 51 are contoured across different parts or portions of the visor 13. The visor 13 has a central portion 53 and two opposed lobes 54 and 55 flanking the central portion 53.

The central portion 53 is a large, convex protrusion. It roughly has a triangular prismatic shape in which the upper surface 50, lower surface 51, and mating surface 52 are the faces or sides of the triangular prism. The lobes 54 and 55 extend outward from the bases of that triangular prism. The central portion 53 is registered above the window 12 and is oriented along or parallel to the horizontal axis 40 without significant deviation.

The lobes 54 and 55 are formed integrally and continuously to the central portion 53 and are mirror identical to each other. The lobe 54 is proximate to the end 41 of the visor 13, outside the central portion 53. The lobe 54 dips or turns downward from the central portion 53 and from the horizontal axis 40, forming a roughly forty-five degree angle with the horizontal axis 40. The lobe 54 extends from the central portion 53 to the end 41, where the lobe 54 terminates at a taper 56. The taper 56 is a triangular-shaped tip where the upper surface 50, the lower surface 51, the free edge 45, and the end 41 all meet. The taper 56 is directed laterally outward, away from the central portion 53.

The lobe 55 is proximate to the end 42 of the visor 13, outside the central portion 53. The lobe 55 dips or turns downward from the central portion 53 and from the horizontal axis 40, forming a roughly forty-five degree angle with the horizontal axis 40. The lobe 55 extends from the central portion 53 to the end 42, where the lobe 54 terminates at a taper 57. The taper 57 is a triangular-shaped tip where the upper surface 50, the lower surface 51, the free edge 45, and the end 42 all meet. The taper 56 is directed laterally outward, away from the central portion 53.

Along the central portion 53, the upper surface 50 is convex, bowed, and roughly rectangular. The upper surface 50 has a slightly convex shape spanning between the opposed lobes 54 and 55, and it has a slightly convex shape spanning between the top 43 and the free edge 45. When the hood 10 is fit to a motorcycle fairing 22 for use, the upper surface 50 is angled downwardly from the top 43 to the free edge 45 directly or normally away from the fairing 22. An imaginary fall line 60 (shown in broken line in FIG. 1) which runs along the upper surface 50 on the central portion 53, bisects this portion of the upper surface 50, and is between the top 43 and the free edge 45, is normal to the horizontal axis 40. The fall line 60 is the line on which a bead of water would run down the upper surface 50 if it were placed at the top of the fall line 60.

The upper surface 50 transitions smoothly and imperceptibly from the central portion 53 to the lobes 54 and 55 outboard of the piers 14 and 15. At the lobe 54, the upper surface 50 is convex, bowed, and roughly triangular. The upper surface 50 has a slightly convex shape spanning between the central portion 53 and the back 21 of the visor 13 proximate the end 41, and it has a slightly convex shape spanning from the top 43 to the free edge 45. When the hood 10 is fit to a motorcycle fairing 22 for use, the upper surface 50 at the lobe 54 is angled downwardly from the top 43 to the free edge 45 obliquely away from the fairing 22. An imaginary fall line 61 (shown in broken line in FIG. 1) which runs along the upper surface 50 on the lobe 54, bisects this portion of the upper surface 50, and is between the top 43 and the free edge 45, is transverse and oblique to the horizontal axis 40. The fall line 61 is the line on which a bead of water would run down the upper surface 50 if it were placed at the top of the fall line 61.

At the lobe 55, the upper surface 50 is convex, bowed, and roughly triangular. The upper surface 50 has a slightly convex shape spanning between the central portion 53 and the back 21 of the visor 13 proximate the end 42, and it has a slightly convex shape spanning from the top 43 to the free edge 45. When the hood 10 is fit to a motorcycle fairing 22 for use, the upper surface 50 at the lobe 55 is angled downwardly from the top 43 to the free edge 45 obliquely away from the fairing 22. An imaginary fall line 61 (not shown, but identical and opposite to the line 61) which runs along the upper surface 50 on the lobe 55, bisects this portion of the upper surface 50, and is between the top 43 and the free edge 45, is transverse and oblique to the horizontal axis 40. This fall line on the lobe 55 has an opposite orientation to the fall line 61 on the lobe 54. This fall line on the lobe 55 is the line on which a bead of water would run down the upper surface 50 on the lobe 55 if it were placed at the top of this fall line on the lobe 55.

Along the entire width of the visor 13 from end 41 to end 42, the upper surface 50 turns downward from the top 43. The upper surface 50 terminates at the free edge 45. Below the free edge 45, the visor 13 includes the lower surface 51 which has several pitches.

Just below the free edge 45 is a lower lip 70 which extends continuously from end 41 to end 42. The lower lip 70 falls back from the free edge 45 down and in toward the back 21 of the hood 10. The lower lip 70 is the upmost part of the lower surface 51. At the central portion 53, the lower lip 70 transitions into an underside of the central portion 53. Here, the lower surface 51 is substantially flat and planar. It is preferably normal to the back plane 34 and is normal to the horizontal axis 40. It extends from the back 21 of the hood 10, and from the top 30 of the window, forwardly to the lower lip 70. The opposed piers 14 and 15 flank the lower surface 51 on the underside of the central portion 53, but for a slender portion 72 of the lower surface 51 that is just in front of the piers 14 and 15 and inboard from the lower lip 70.

These slender portions 72 of the lower surface 51 in front of the piers 14 and 15 are contiguous to larger triangular areas 71 of the lower surface 51 on the undersides of each lobe 54 and 55. These triangular areas 71 are oriented diagonally; they angle inward to the center of the hood 10 and are transverse with respect to both the underside of the central portion 53 and the back plane 34.

The piers 14 and 15 extend downward from visor 13. The piers 14 and 15 flank and bound and define the window 12 at its opposed sides 32 and 33 and provide shade along the sides. The base rail 16 extends along the bottom 31 of the window 12 between the opposed piers 14 and 15. The piers 14 and 15 and the base rail 16 are integral and monolithic pieces of the body 11 below the visor 13.

The piers 14 and 15 are mirror identical. The pier 14 is proximate to the left side 32 of the window 12. The pier 14 has a top 83 formed to the visor 13 and an opposed bottom 84 formed to the base rail 16. The pier 14 is oriented obliquely such that the top 83 of the pier 14 is laterally further away from the left side 32 of the window 12 than is the bottom 84 of the pier 14. Thus, from the rider's perspective, the pier 14 flares outward from bottom to top. From the bottom 84, the pier 14 projects forwardly to the free edge 45 of the visor 13.

The pier 14 includes a front surface 80, an inner surface 81, and an outer surface 82. The front surface 80 is directed toward the rider, the inner surface 81 is directed in toward the window 12, and the outer surface 82 is directed laterally outward away from hood 10. The front surface 80 curves concavely down from the slender portions 72 of the lower surface 51 to the base rail 16. The front surface 80 is directed forwardly, toward the rider.

The inner surface 81 extends from the front surface 80 toward the back 21 of the hood 10 and the lip 24 at the left side 32 of the window 12. The inner surface 81 is substantially planar between the front surface 80 and the left side 32 except where the pier 14 meets the visor 13 and the base rail 16, at which points the inner surface 81 is concave and rounded. At the left side 32 of the window 12, the inner surface 81 is linear.

The outer surface 82 extends from the front surface 80 to the back 21 of the hood 10 opposite the inner surface 81. The outer surface 82 is substantially planar between the front surface 80 and the back 21 except where the pier 14 meets the triangular area 71 of the visor 13 and the base rail 16, at which points the outer surface 82 is convex and rounded.

The pier 15 is opposite the pier 14. Pier 15 is proximate to the right side 33 of the window 12. Pier 15 has a top 93 formed to the visor 13 and an opposed bottom 94 formed to the base rail 16. The pier 15 is oriented obliquely such that the top 93 of the pier 15 is laterally further away from the right side 33 of the window 12 than is the bottom 94 of the pier 15. Thus, from the rider's perspective, the pier 15 flares outward from bottom to top. From the bottom 94, the pier 15 projects forwardly to the free edge 45 of the visor 13.

The pier 15 includes a front surface 90, an inner surface 91, and an outer surface 92. The front surface 90 is directed toward the rider, the inner surface 91 is directed in toward the window 12, and the outer surface 92 is directed laterally outward away from hood 10. The front surface 90 curves concavely down from the slender portions 72 of the lower surface 51 to the base rail 16. The front surface 90 is directed forwardly, toward the rider.

The inner surface 91 extends from the front surface 90 toward the back 21 of the hood 10 and the lip 24 at the right side 33 of the window 12. The inner surface 91 is substantially planar between the front surface 90 and the right side 33 except where the pier 15 meets the visor 13 and the base rail 16, at which points the inner surface 91 is concave and rounded. At the right side 33 of the window 12, the inner surface 91 is linear.

The outer surface 92 extends from the front surface 90 to the back 21 of the hood 10 opposite the inner surface 91. The outer surface 92 is substantially planar between the front surface 90 and the back 21 except where the pier 15 meets the triangular area 71 of the visor 13 and the base rail 16, at which points the outer surface 82 is convex and rounded.

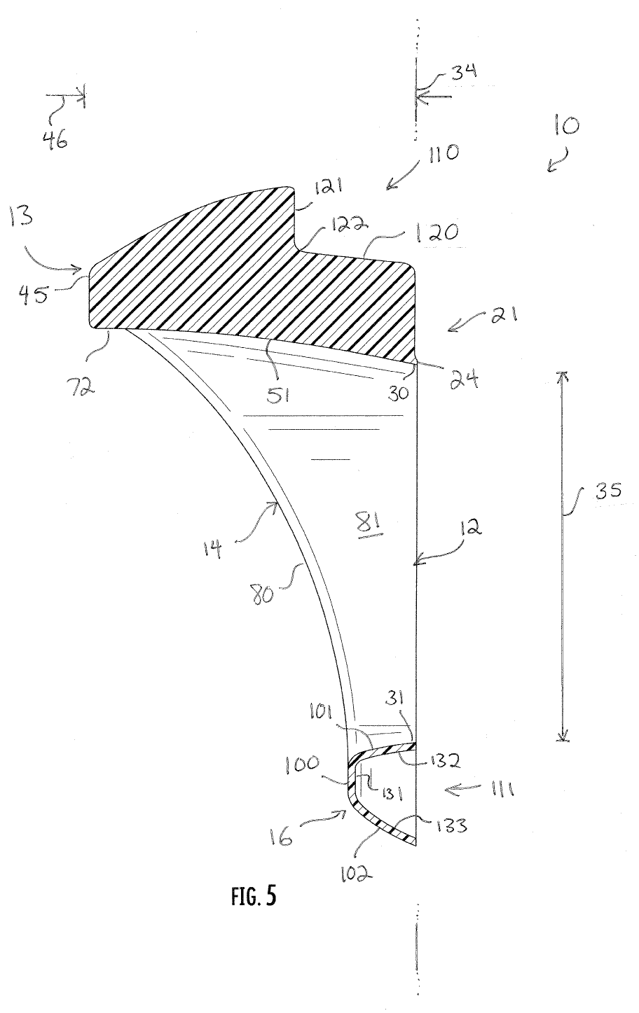

The base rail 16 extends along the bottom 31 of the window 12 between the opposed piers 14 and 15 and, together with the visor 13, flank and bound and define the window 12. The base rail 16 is generally linear and straight between the piers 14 and 15 and is oriented parallel to the horizontal axis 40. The base rail 16 is shown in FIGS. 1 and 2 but is also shown well in the section view of FIG. 5, taken along the line 5-5 from FIG. 3.

The base rail 16 has a front surface 100, an inner surface 101, and an outer surface 102. The front surface 100 is directed toward the rider of the motorcycle and is generally planar and flat, although very narrow between the inner and outer surfaces 101 and 102. The front surface 100 extends continuously between and is contiguous to the front surfaces 80 and 90 of the piers 14 and 15. Indeed, the front surface 80 of the pier 14 extends down from below the visor 13, wraps around and seamlessly becomes the front surface 100 of the base rail 16, and then wraps up and seamlessly becomes the front surface 90 of the pier 15.

The inner surface 101 is directed in toward the window 12. The inner surface 101 extends from the front surface 100 to the lip 24 at the bottom 31 of the window 12. The inner surface 101 is short and substantially planar along its short length. The inner surface 101 is also substantially planar between the piers 14 and 15 except just where the inner surface 101 meets those piers 14 and 15. The inner surface 101 extends continuously between and is contiguous to the inner surfaces 81 and 91 of the piers 14 and 15. The inner surface 81 of the pier 14 extends down from below the visor 13, wraps around and seamlessly becomes the inner surface 101 of the base rail 16, and the wraps up and seamlessly becomes the inner surface 91 of the pier 15.

The outer surface 102 is directed downward away from the hood 10. The outer surface 102 extends from the front surface 100 to the bottom of the hood 10. The outer surface 102 is short and slightly convex along its short length. The outer surface 102 is substantially planar between the piers 14 and 15 except just where the outer surface 102 meets those piers 14 and 15. The outer surface 102 extends continuously between and is contiguous to the outer surfaces 82 and 92 of the piers 14 and 15. The outer surface 82 of the pier 14 extends down from below the visor 13, wraps around and seamlessly becomes the outer surface 102 of the base rail 16, and the wraps up and seamlessly becomes the outer surface 92 of the pier 15.

Turning now primarily to the rear perspective views of FIGS. 3 and 4 and to the section view of FIG. 5, on the back 21, the hood 10 has a mating surface 52 covering essentially the entire back 21 of the hood 10. The hood 10 is configured to snugly nest and mate against the motorcycle fairing 22. The fairing 22 has a front surface and the mating surface 52 receives and snugly mates to that surface in continuous contact.

The mating surface 52 is on the back 21 of the body 11 and includes an upper channel 110 and a lower channel 111 formed in communication with each other. The upper and lower channels 110 and 111 fit against the motorcycle fairing 22.

The upper channel 110 extends across the visor 13 along the back 21 of the body 11. It has a first surface 120 and a second surface 121 which meet at an inner corner and are arranged to form the upper channel 110 as a channel, notch, or depression in the body 11 of the hood 10. The first surface 120 is roughly horizontal, projecting forwardly from the back plane 34 roughly normal thereto. It generally follows the contour of the upper surface 50: along the central portion 53, the first surface 120 is slightly concave and bowed, and at the opposed lobes 54 and 55, the first surface 120 transitions smoothly and immediately and turns down at roughly a forty-five degrees angle with respect to the horizontal axis 40.

The first surface 120 terminates in the body 11 at the concave inner corner 122, and from there the second surface 121 rises up to the top 43 of the visor 13. The second surface 121 is generally planar and has a constant height between the first surface 120 and the top 43. The second surface 121 is substantially parallel to the back plane 34. The first and second surfaces 120 and 121 are oriented at approximately a ninety-degree angle with respect to each other, thereby forming the upper channel 110 adapted to snugly receive the fairing 22.

As can be seen in the section view of FIG. 5, the first surface 120 of the upper channel 110 starts at the back plane 34 and extends forwardly beyond the base rail 16. The second surface 121 of the upper channel 110 is disposed forward of the base rail 16.

The lower channel 111 is in the base rail 16 and the piers 14 and 15. The lower channel 111 extends across both the piers 14 and 15 and the base rail 16 along the back 21 of the body 11, at the back plane 34. The lower channel 111 includes first, second, and third surfaces 131, 132, and 133. These surfaces 131-133 cooperate to form a major concavity 134 in the base rail 16 and minor concavities 135 and 136 in the piers 14 and 15, respectively, extending contiguously from the major concavity, where all three concavities 133-136 are in communication with each other.

The first surface 131 opposes the front surface 100 of the base rail 16 and opposes the front surfaces 80 and 90 in the piers 14 and 15, respectively. The first surface 131 preferably extends continuously around the piers 14 and 15 and the base rail 16 without interruption. It is relatively narrow, but at the tops 83 and 93 of the piers 14 and 15, the first surface 131 widens considerably before it transitions into the upper channel 110.

The second and third surfaces 132 and 133 flank the first surface 131. They extend continuously around the piers 14 and 15 and the base rail 16 without interruption. The second and third surfaces 132 and 133 have a generally constant depth or length between the first surface 131 and the back plane 34 except proximate the tops 83 and 93 of the piers 14 and 15, where they decrease and size.

Thus, the major concavity 134 in the base rail 16 is relatively deep compared to the minor concavities 135 and 136 in the piers 14 and 15. Moreover, while the major concavity 134 maintains a relatively constant profile along the base rail 16, the minor concavities 135 and 136 both flatten toward the upper channel 110.

Referring now to FIGS. 6-8, in operation, the hood 10 is preferably mounted to a motorcycle fairing 22. FIGS. 6-8 show a fairing 22 without any other components or features of a motorcycle for simplicity and clarity of the drawings. The fairing has an upper rail 140 projecting over a flatter dashboard 141. The dashboard 141 includes a lower rail 142 that projects outward as well.

When applied to the fairing 22, the mating surface 52 fits against the fairing 22 and the dashboard 141 in uninterrupted, continuous contact. The upper channel 110 snugly receives the upper rail 140 and the lower channel 111 snugly receives the lower rail 142.

The second surface 121 of the upper channel 110 is in full, direct, and continuous contact with a forward surface of the upper rail 140. The first surface 120 of the upper channel 110 is in full, direct, and continuous contact with an underside surface of the upper rail 140. The corner between the forward and underside surfaces of the upper rail 140 is in full, direct, and continuous contact with the inner corner 122.

Likewise, the lower rail 142 has a forward surface, an upper surface, and a lower surface. The first surface 131 of the lower channel 111 is in full, direct, and continuous with the forward surface of the lower rail 142. The second surface 132 of the lower channel 111 is in full, direct, and continuous with the upper surface of the lower rail 142. The third surface 133 of the lower channel 111 is in full, direct, and continuous with the lower surface of the lower rail 142.

The back 21 of the body 11 of the hood 10 is in full, direct, and continuous with the fairing. The minor concavities 135 and 136 of the piers 14 and 15 are in full, direct, and continuous with the dashboard 141. The window 12 fits over and around the electronic display 23. In this way, the electronic display 23 is visible but shaded from the sun.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

1. A hood device comprising:
a solid body bounding and defining a window, the window having a top, a bottom, and opposed sides, wherein the solid body includes:
a visor projecting above the top of the window;
opposed piers flanking the window at the opposed sides thereof; and
a base rail extending along the bottom of the window between the opposed piers;
a mating surface on a back of the body, wherein the mating surface includes:
an upper channel across the visor along the back of the body; and
a lower channel extending continuously across the piers and the base rail along the back of the body.

2. The hood device of claim 1, wherein:
the visor extends along a horizontal axis between opposed ends of the visor;
the visor includes a central portion above the window; and
the visor includes opposed lobes outside the central portion and outboard of the piers.

3. The hood device of claim 2, wherein the lobes turn downward from the horizontal axis.

4. The hood device of claim 1, further comprising a back plane at the back of the body, wherein the upper channel, the lower channel, and the window are at the back plane.

5. The hood device of claim 4, wherein the upper channel includes a first surface extending forwardly from the back plane and a second surface extending upwardly from the first surface.

6. The hood device of claim 5, wherein the second surface of the upper channel is forward of the base rail.

7. The hood device of claim 4, wherein the lower channel includes a major concavity along the base rail which is in communication with minor concavities in the piers, the minor concavities extending contiguously from the major concavity and flattening toward the upper channel.

8. The hood device of claim 1, wherein:
the visor projects forwardly to a free edge; and
the piers project forwardly from the base rail to the free edge of the visor.

9. A hood device comprising:
a solid body bounding and defining a window;
a back surface of the solid body including an upper channel and a lower channel, wherein the upper channel is configured to mate against an upper rail of a motorcycle fairing and the lower channel is configured to mate against a dash of the motorcycle fairing;
a visor projecting forwardly from the back surface above the window;
opposed piers flanking the window; and
a base rail extending between piers below the window.

10. The hood device of claim 9, wherein:
the visor extends along a horizontal axis between opposed ends of the visor;
the visor includes a central portion above the window;
the visor includes opposed lobes outside the central window and outboard of the piers; and
the lobes turn downward from the horizontal axis.

11. The hood device of claim 9, further comprising a back plane at the back surface of the body, wherein the upper channel, the lower channel, and the window are at the back plane.

12. The hood device of claim 11, wherein the upper channel includes a first surface extending forwardly from the back plane and a second surface extending upwardly from the first surface.

13. The hood device of claim 12, wherein the second surface of the upper channel is forward of the base rail.

14. The hood device of claim 11, wherein the lower channel includes a major concavity along the base rail which is in communication with minor concavities in the piers, the minor concavities extending contiguously from the major concavity and flattening toward the upper channel.

15. The hood device of claim 9, wherein:
the visor projects forwardly to a free edge; and
the piers project forwardly from the base rail to the free edge of the visor.

16. A hood device comprising:
a solid body defining a back plane, the solid body bounding a window at the back plane having a top, a bottom, and an opposed sides, wherein the solid body includes:
a visor projecting forwardly from the back plane above the top of the window; and
opposed piers flanking the window at the opposed sides thereof;
a mating surface at the back plane of the body, wherein the mating surface includes an upper channel extending across the visor, the mating surface configured for mating contact with a fairing of a motorcycle.

17. The hood device of claim 16, wherein the solid body further comprises a base rail extending along the bottom of the window between the opposed piers.

18. The hood device of claim 17, wherein the mating surface further includes a lower channel extending continuously across the piers and the base rail.

19. The hood device of claim 18, wherein:
the upper channel includes a first surface extending forwardly from the back plane and a second surface extending upwardly from the first surface; and
the lower channel includes a major concavity along the base rail which is in communication with minor concavities in the piers, the minor concavities extending contiguously from the major concavity and flattening toward the upper channel.

20. The hood device of claim 16, wherein:
the visor extends along a horizontal axis between opposed ends of the visor;
the visor includes a central portion above the window;
the visor includes opposed lobes outside the central window and outboard of the piers; and
the lobes turn downward from the horizontal axis.
